(19) United States
(12) Patent Application Publication
(10) Pub. No.: US 2016/0357795 A1
(43) Pub. Date: Dec. 8, 2016

(54) METHOD AND APPARATUS FOR DATA MINING

(71) Applicant: ORICANE AB, Lulea (SE)

(72) Inventor: Mikael Sundstrom, Lulea (SE)

(21) Appl. No.: 15/036,623

(22) PCT Filed: Nov. 17, 2014
(86) PCT No.: PCT/SE2014/051358

§ 371 Date: May 13, 2016

(30) Foreign Application Priority Data
Nov. 22, 2013 (SE) 1351392-4

(51) Int. Cl. G06F 17/30

(52) U.S. Cl. CPC G06F 17/30327; G06F 17/30324; G06F 17/30424; G06F 17/30598

(57) ABSTRACT

The invention is related to a method, apparatus and a computer program product for data mining and more particularly, but without limitation, including data mining for processing business intelligence reports, which efficiently represent the data records in a way that minimizes storage of redundant information and at the same time enables extremely efficient construction of breakdowns, efficiently represent breakdowns with minimum memory overhead and at the same time facilitate efficient traversal of the tree structures represented to enable fast generation of reports and manage update of the data records to minimize the impact on existing breakdowns as well as minimize the computations required to update reports to reflect the changes after an update.

### TECHNICAL FIELD

The present invention is related to the field of data mining and more particularly but without limitation to data mining for processing business intelligence reports.

### BACKGROUND

The purpose of data mining, herein this context data mining includes processing of data but also searching for pattern in large sets of data, for application in business intelligence applications such as processing business intelligence reports, is to analyze collected data for instance from business transactions to achieve an understanding of what has happened in the past. There can be many reasons for performing this kind of analysis and some examples are: to investigate the impact on sales after launching a new commercial, to investigate the difference in sales across product segments and geographical markets, or to investigate variations in sales over different seasons.

For a small scale business operation, typically with a limited number of collected data for a limited number of transactions and/or few different products, this kind of analysis can normally be done quite easily using brute force methods, but for large scale business operations, large technically complicated and hence therefore normally costly data analysis tools such as tools comprising data analyzing and processing computer programs are typically required, and therefore today, it is common to perform this kind of analysis at a low time granularity such as on a weekly basis only. As a consequence many business organisations lack an efficient and precise data analysis tool for processing collected data for processing business intelligence reports. The same problem occurs also in other organisations and applications requiring similar kind of analysis of collected data.

### DESCRIPTION OF THE INVENTION

Aspects and embodiments of the present invention will be described as follows, but first an overall framework and problems to be solved will be described for a better understanding of the invention.

Collected data typically consists of data records, where each data record has a number of fields that can be regarded as belonging to a number of basic field types. Some of these fields contain real number values, and/or integers; whereas some contains text values; and some contains time stamps. In addition to these basic field types there are also selector fields, which are lists of data records of the same type from which individual sub-records referred to by unique tags can be selected. There can also be other fields as well, but only the above given, which can be considered to be the major types in this context, are given for a better understanding of the problem solved by the invention.

Across these three field types, so-called “class fields” can be defined, which can be used to separate records into different classes. Herein this context, reference is given to three kinds of class fields, “explicit,” “implicit” and “synthetic” class fields, but without any limitation to these only.

By an explicit class field, herein is meant a class field where the data record, typically a value, stored in the field can be used directly for classification of the data record. For example color such as: red, blue, white, yellow; country, for instance: Sweden, Finland, Norway; and vehicle type such as: bicycle, motorcycle, car, airplane. Explicit class fields are typically associated with text fields.

By an implicit class field, herein this context is meant a class field which is typically defined by either a time stamp or a value and where the class field is defined by a range. For example all transactions that occurred during the same day is in the same class field or all transactions where the sales price is in a certain range is in the same class field.

By a synthetic class field, herein this context is meant a class field which is not present in the data record originally but rather derived from values in other fields. For example a product which is sold in four colors and the data records keeps track of sales across individual colors, then the most sold color can be generated as a synthetic class field.

In addition to class fields, so-called “selector fields” can be used to separate partial records into different class fields.

Herein, commonly is referred to fields that are neither class fields nor selector fields as so-called “value fields”.

Typically, but without any limitation to, a primary purpose of data analysis tools such as business intelligence tools is to have the data records broken down in aggregated form and being able to generate comprehensible summary reports rather than looking at each individual data record. Herein this context a “breakdown” is defined as a tree structure of layered data, where each layer corresponds to a class field. Each class field can occur at most once in each breakdown and not all class fields needs to be present.

While the breakdown defines a hierarchy of class fields, in the following also referred to as “classes”, typically it does not in itself constitute sufficient information to represent a comprehensible summary report. Typically, the first layer of the breakdown represents a root node in a multi-branch tree structure and each sub-tree directly below the root node represents a value of the class field, or class, associated with the root node. The breakdown is defined recursively in this fashion until reaching the leaves associated with the last class field.

The data records themselves constitute the bottom of the breakdown and are located below the leaves.

For example, if the vehicle type, country, and color, previously mentioned, are used as the breakdown, there will be a root node with bicycle, motorcycle, car, and airplane as children. Each node at the second layer will have Sweden, Finland, and Norway as children and each node at the third layer will have red, blue, white, and yellow as leaves. The sequence of class fields encountered when traversing from the root to a leaf is called a path and the set of paths of a given breakdown corresponds to a partition of the set of data records. That is, each data record is accessible via exactly one path. For example, the path {car, Finland, blue} reaches all data records representing blue cars in Finland.

But, a breakdown in itself does not make sense without any “aggregates”. To obtain an aggregate, or aggregated data records in the leaves of the breakdown, some aggregate function has to be applied to all data records associated with the leaf and the resulting aggregate is stored in the leaf. Similarly, to compute the aggregate of a node, some aggregate function is applied to all aggregates of the children nodes and the resulting aggregate is stored in the node itself. To compute all aggregates this is, in effect, performed bottom-up recursively until the root aggregate has been computed.

The aggregate functions used can be complex and involve several fields from underlying data records or they can be very simple and only include a single field. An example of a simple aggregate function is to just accumulate the values of a certain field in the parent and then, for example to generate sales reports broken down in different ways.

Having described the overall framework of data analysis tools such as business intelligence tools and how to have the data records broken down in aggregated form and being able to generate comprehensible summary reports, three main problems that needs to be solved and how these are solved by embodiments of the invention will be further described, without any limitation to these particular problems or to these being the main problems.

A first main problem is to efficiently represent the data records in a way that minimizes storage of redundant information and at the same time enables extremely efficient construction of breakdowns.

A second main problem is to efficiently represent breakdowns with minimum memory overhead and at the same time facilitate efficient traversal of the tree structures represented to enable fast generation of reports.

A third main problem is to manage update of the data records to minimize the impact on existing breakdowns as well as minimize the computations required to update reports to reflect the changes after an update.

In accordance with different aspects and embodiments of the present invention, there is provided a method, apparatus and a computer program product for data mining and more particularly, but without limitation, including data mining for processing business intelligence reports, according to claims 1, 10 and 11. Further embodiments are set forth in the dependent claims and advantages obtained by these embodiments will be discussed as follows.

The embodiments are particularly advantageous as they efficiently represent the data records in a way that minimizes storage of redundant information and at the same time enables extremely efficient construction of breakdowns.

Another advantage of the embodiments is that they efficiently represent breakdowns with minimum memory overhead and at the same time facilitate efficient traversal of the tree structures represented to enable fast generation of reports.

Yet another advantage of the embodiments is that they manage update of records to minimize the impact on existing breakdowns as well as minimize the computations required to update reports to reflect the changes after an update.

### BRIEF DESCRIPTION OF THE DRAWINGS

In the following embodiments of the present invention will be described in more detail by way of example only by making reference to the drawings in which:

FIG. 1a is an example of a tree-structure in which embodiments of the invention can be implemented;

FIG. 1b is an example of a packed array containing group fields of different sizes;

FIG. 2 illustrates a global record mapping scheme for the packed array from FIG. 1b;

FIG. 3 is an example of a master key;

FIG. 4a-b is an example of records stored in consecutive memory locations;

FIG. 5 is an example of a breakdown consisting of four levels;

FIG. 6 is a flowchart illustrating an embodiment of the method accord to the invention; and

FIG. 7 is a block diagram of an embodiment of a data processing system for implementing embodiments of the present invention.

### DESCRIPTION OF EMBODIMENTS OF THE INVENTION

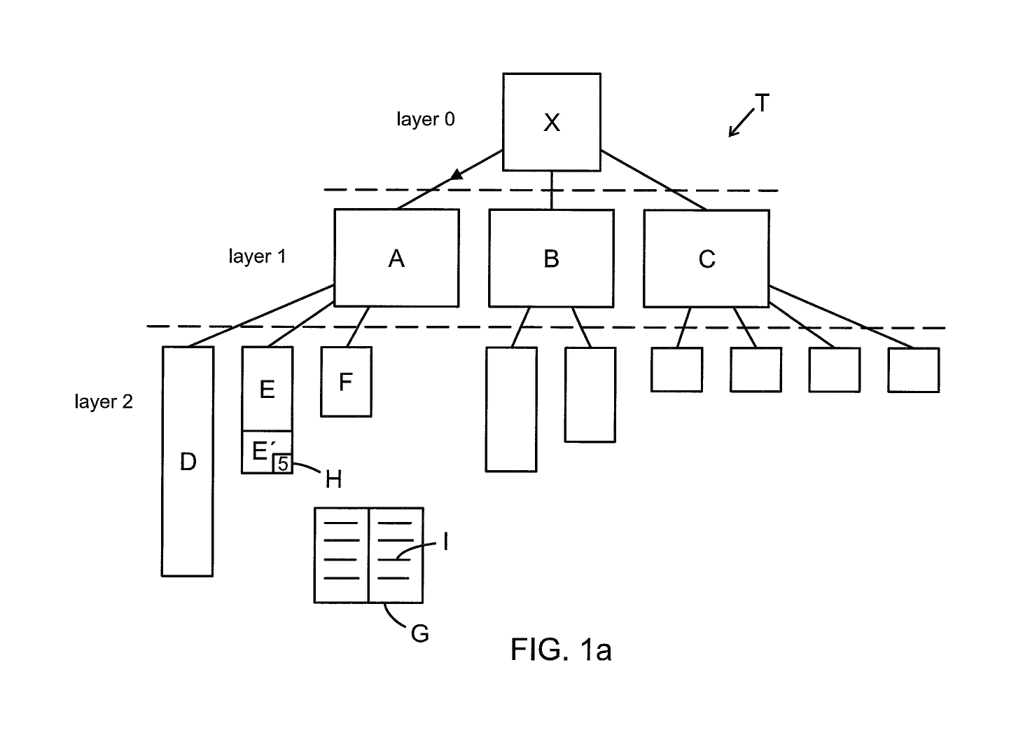

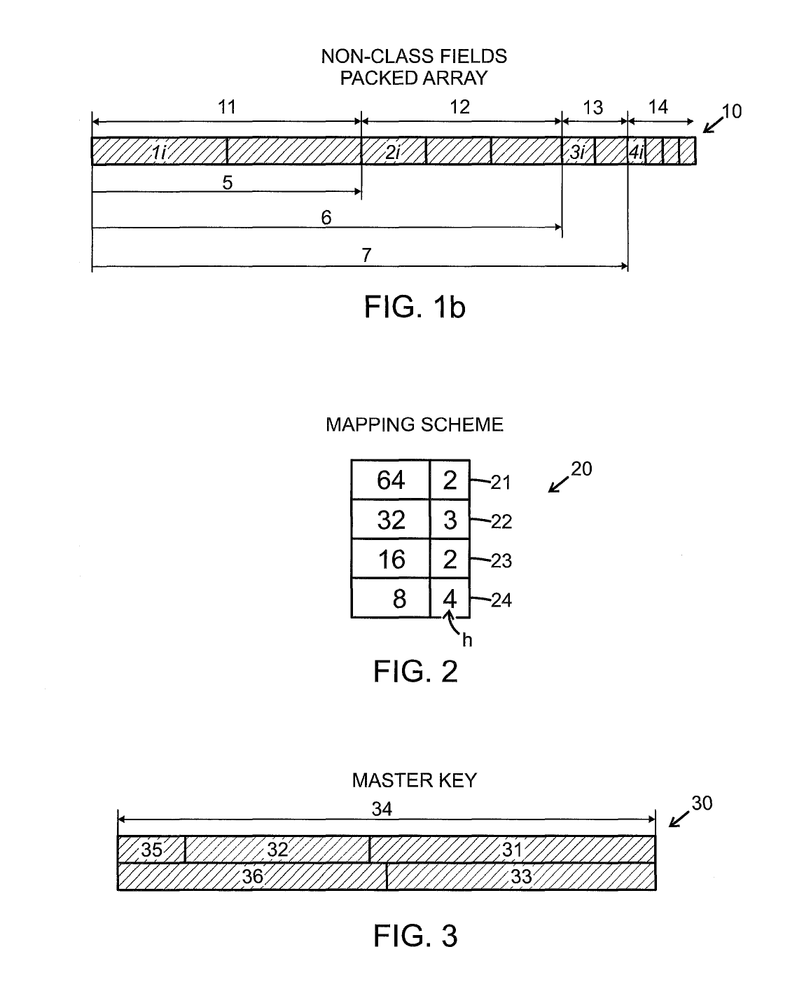

Embodiments of the present invention will be described as follows, but first a multi-branch tree structure and a typical breakdown will be illustrated and described with reference to FIG. 1a. Typically, a first layer layer 0 of a breakdown (illustrated with an arrow) represents a root node X in a multi-branch tree structure and each sub-tree A, B, C directly below the root node X represents a value of a class field, or class, associated with the root node X. The breakdown is defined recursively in this fashion until reaching a leaf E associated with the last class field E. Data records E′ themselves constitute the bottom of the breakdown and are located below the leaf E.

### Data Record Representation—The First Main Problem

The first main problem solved by the embodiments is that they efficiently represent the data records in a way that minimizes storage of redundant information and at the same time enables extremely efficient construction of breakdowns. According to various embodiments of the present invention, this is provided as explained below.

### Basic Representation:

In a basic representation, the same number of bits, typically 32 or 64, is used to represent each field. This means that 32/64-bit integers, signed or unsigned, and 32/64-bit real numbers can be represented. Time stamps are essentially represented as the number of time units elapsed since a certain “start of time” and are mapped to integers. In Unix Time for instance, a time stamp is represented as the number of seconds that have elapsed since midnight Jan. 1, 1970.

Text fields can vary quite heavily in length and in many cases text fields represents some kind of property, and thus corresponds to a value of an enumerated type in a programming language, whereas some text columns, typically only one or a few, represents, or corresponds to, an identifier of the record itself. Replications are extremely common for property text fields and these are therefore typically stored in a dictionary G and represented by an integer in the data records E′. For simplicity, the same approach can be used for identifier text fields since it is not necessarily known before hand which kind it is. As an option, the text fields can be compressed further using some available text compression algorithm to obtain a dictionary of compressed/encoded strings, as opposed to clear text strings, thus reducing memory requirements for the dictionary data structure. Any type of dictionary data structure can be used to represent the dictionary but some kind of compressed trie to achieve fast access and low memory footprint is typically used.

In addition to the above mentioned, there can also be text fields containing free text which may be arbitrarily large. When present, such text field are typically compressed using some available text compression algorithm and represented in the data record by a reference to the compressed text.

According to various aspects of the present invention, each or all of the above can be exploited.

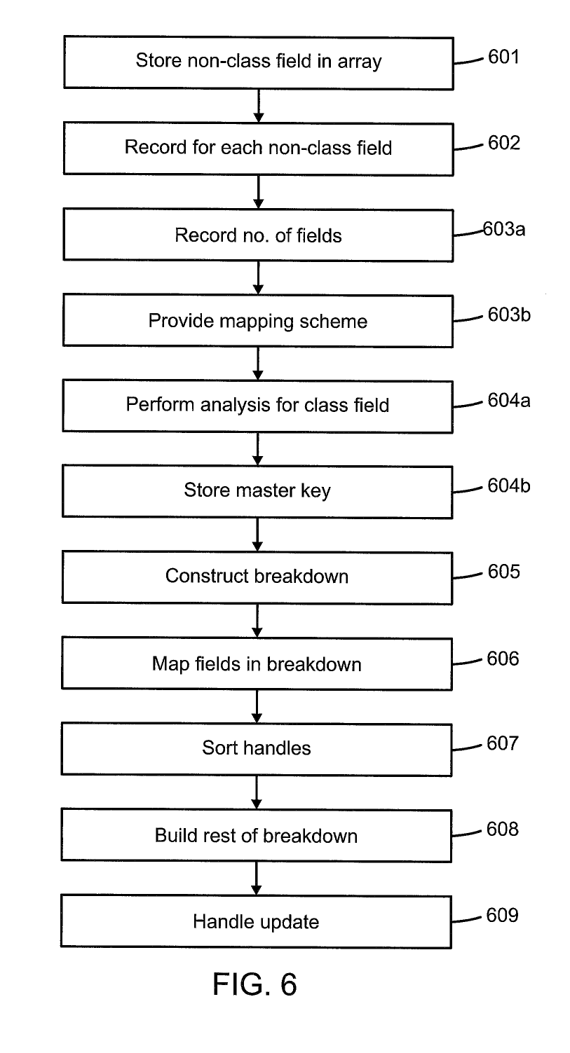

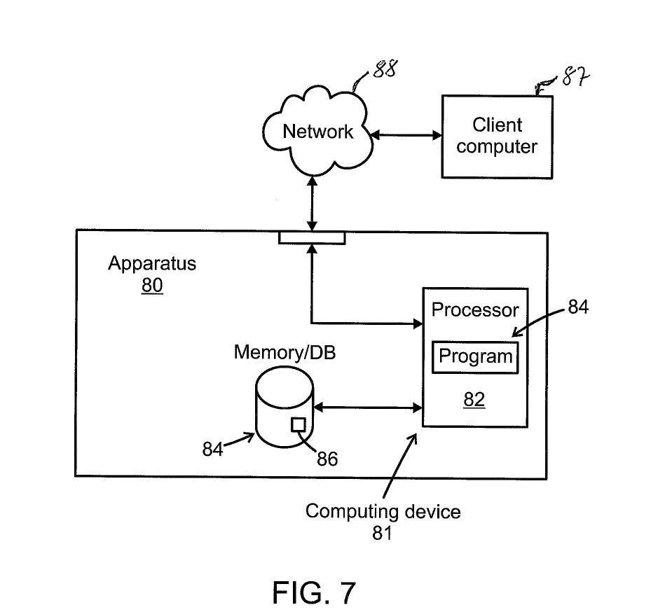

Now is also referred to FIG. 6 illustrating a flow-chart of an embodiment, and to FIG. 7 illustrating a computing device 81 including a processor 82 and one or more computer memories 84 having consecutive memory locations 86 for providing and handling the layered tree structure of the data records E′ described above in relation to FIG. 1 a.

The computing device, typically a computer, can be implemented in an apparatus 80 for data mining and embodied as a computer program product, for instance stored on a computer readable storage medium or a downloadable computer program including computer application products for data mining configured to be run on a computer processor controlled by a memory having instructions therefore. The computer program product comprises program code means, which when run on a processor 82 and being stored in one or more computer memories 84 configures the computing device 81 to perform the various embodiments of the method as follows. One or more clients 87, such as client computers or physical users (not shown) may be connect to or communicate with the computing device 81 thereby using the computing device or performing the method according to various embodiments of the invention. The client(s) 87 may be connected in any way including wireless or wired connections, and possibly one or more intervening communication network 88.

### Advanced Representation:

In many cases, the actual number of bits required to represent different fields varies a lot. According to an aspect of the present invention, this can be exploited to obtain a reduction in memory consumption, and to increase locality of accesses and improve the speed of computation. To achieve the best result, according to an embodiment, two different approaches are combined where the selected approach depends on whether the field is a class field or not.

In FIG. 1b is illustrated an example of a packed array 10 containing groups 11, 12, 13, 14 of fields different sizes 64-bit, 32-bit, 16-bit and 8-bit. There are two 64-bit fields 1₁, 1₂ at offset 0 bits (offset is with respect to the base of the array), three 32-bit fields 2₁, 2₂, 2₃ at offset 128 bits 5, two 16-bit fields 3₁, 3₂ at offset 224 bits 6, and four 8-bit fields 4₁, 4₂, 4₃, 4₄ at offset 256 bits 7.

For non-class fields, such as numbers and timestamps, there are some variations with respect to how many bits that are actually necessary to represent the number. From a point of view of compression, it is advantageous to use exactly as many bits as required for each field. On the other hand, number fields are heavily accessed during computations and should therefore typically be aligned to reduce computation overhead. As a compromise, a scheme where number fields are represented by 8, 16, 32, or 64 bits can be used. According to an embodiment, extension to any multiple of 32 or 64 bits, depending on hardware architecture, is possible. The non-class part of each data record E′ can be represented by a number of 11, 12, 13, 14 arrays of non-class fields 1ᵢ, 2ᵢ, 3ᵢ, 4ᵢ stored 601 in a packet array 10 (See FIG. 1b below) that occupies consecutive memory locations 86 starting with the array 11 of fields that requires the largest representation, followed by the second 12 largest and so on. In order to keep track of how each number/time stamp field is represented and how to access each individual field, it is recorded 602 for each field 1ᵢ, 2ᵢ, 3ᵢ, 4ᵢ which group 11, 12, 13, 14 it belong to and also the index i of the field 1, within its group 11. By also recording 603a the number n of fields in each group 11, 12, 13, 14, the location of an individual field 11, 12, 13, 14 of a data record as an offset from the start of the array 10 containing the fields 1₁, 1₂ that require the largest representation can easily be computed. While this book keeping may appear complex at a first glance it is not required for each individual record since all records are represented and mapped 603b in the memory in the same way. Hence, according to an embodiment, there is a global scheme for mapping records to the memory across the whole data base 84. Herein, the term “data base” includes one or more memories, or other data storages.

FIG. 2 illustrates the global record mapping scheme 20 for the packed array 10 from FIG. 1b.

For class fields an analysis is performed 604a for each individual field to find the minimum number of bits required for representing the field. This can be achieved by counting the number of unique values that occurs in that field and taking the ceiling of the logarithm with base two of that number. For example, if there are 75 different values the field is represented using 7 bits (0 . . . 127).

Depending on the expected dynamics of the data base (memory), we may or may not choose to use one or a few extra bits to handle an increase in variety without having to reconfigure the field representation.

According to an embodiment, the class field values of each data record E′ are stored 604b tightly packed in the memory and constitute a master key for the data record. While the master key is preferably embedded in an unsigned integer if it is reasonably small, it is essentially an array of bits and can thus be stored in a quite flexible manner. However, similarly to non class fields, typically there is a global scheme for mapping records to individual parts of the master key that also takes into account the storage of the master key.

In FIG. 3 a 64-bit master key 30 representing a 17-bit class field 31, an 11-bit class field 32 and a 16-bit class field 33 is illustrated. The layout of the class fields takes into account the machine word 34 size, which in this example is 32-bit, to avoid that any class field is stored across a machine word boundary as this could potentially lead to a performance penalty during computation. Also note that there are four 35 and sixteen 36 unused bits in each machine word respectively.

### Breakdown Representation:

The second main problem solved by the embodiments of the present invention is to efficiently represent breakdowns with minimum memory overhead and at the same time facilitate efficient traversal of the tree structures represented to enable fast generation of reports.

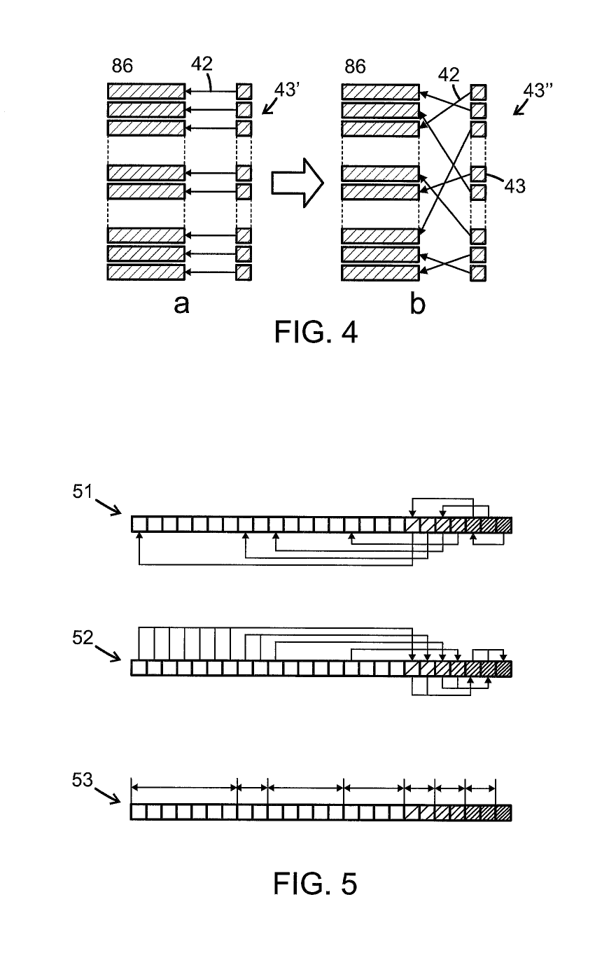

Now is referred to FIGS. 4a and b.

Typically, a breakdown is essentially built from an ordered list of class fields where the first field represents the top level, the second field the second level of a tree structure and so on.

Since the data records may be quite large and there may be several breakdowns concurrently in use it is not possible to move data records around when constructing breakdowns. Therefore, the breakdown construction is started by constructing 605 an array 43′ of handles 43. For each data record, corresponding to memory location, 86 there is a handle 43 and the handle 43 contains a reference to the record 86 it is associated with. Furthermore, the handle 43 contains a slave key which is a subset of the master key 30 containing only the class fields included in the breakdown. The slave key is represented as an unsigned integer large enough to contain all fields required for the breakdown.

Since the slave key is typically crucial for breakdown construction, typically the fields included in the breakdown are mapped 606 such that the last field occupies the least significant bits of the slave key, the next last field occupies the next unused least significant bits and so on. If there are unused bits of the slave key when all fields have been stored these are zeroed. By this key mapping the construction of the tree structure can start by sorting 607 the handles 43 according to the slave keys. This will achieve a sorted array 43″ of handles 43 where handles 43 with identical slave keys are grouped together. If it is necessary to preserve the order between handles with identical slave keys the sorting algorithm has to be chosen accordingly and if some particular order needs to be imposed an additional class field selected to impose said order can be added as the last class field of the breakdown configuration.

FIG. 4a illustrates the records stored in consecutive memory locations 86, the references/pointers from handles to records 42 and the corresponding unsorted array 43′ of handles 43. In FIG. 4b the resulting sorted array 43″ of handles 43 after sorting the handles 43 in increasing order with respect to the slave keys is illustrated.

After completing the sorting step, typically the rest of the breakdown is built 608 in the same array 43″ as the handles after the handles, which represents the bottom of the breakdown, such that all leaves are stored in the array locations directly following the handles, all parents nodes of the leaves are stored in the array locations immediately following the leaves and so on until reaching the last location in use which contains the root node.

The construction can be explained as follows. The current depth is tracked, which initially equals the number of levels of the breakdown, the current offset, which initially refers to the offset of the first handle, and the next and free offset which both initially refer to the offset of the first leaf to build. Across the construction, next offset refers to the first location of a node to be constructed that is not part of the current level under construction whereas the free offset refers to the location where to construct the next node. Nodes are represented by a chunk structure that contains a base, which is the offset to its first child, or first handle if it is a leaf, key, which is a copy of the slave key size, which is the size of the node measured in number of children (or handles if it is a leaf), and density, which is the number of handles in the subtree rooted at the node. Each chunk also has a reference to the offset of its parent node. It is assumed that handles can be accessed in the same fashion as chunks. Typically, the algorithm comprises three nested loops where the outermost loop carries out the entire construction bottom up level by level, the intermediate loop executes construction of one level by looping through the nodes of that level, and the innermost loop performs construction of a single node, or leaf, by processing the children nodes, or handles, and attaching the parent node to these while updating the size and density fields of the parent. Upon initiation, the handles occupies locations 1 to number of handles, and next and free offset are both set to number of handles+1 whereas the current offset, which is the offset of the current child/handle to be processed, is set to 1.

In the outermost loop, the depth is decreased for each round and next offset is set to a free offset, after completing the round, and the loop carries on until the last round, where the depth is zero, is completed and next offset−1 is the location of the root of the breakdown. In the intermediate loop, the free offset is the location of the node to be constructed whereas next offset represents the first offset of the node at the level above the current level in construction. Hence, the last children node/leaf/handle of a node at the current level under construction is located at next offset−1. Before entering the innermost loop, the current offset, which is the offset of the first child, is stored in the base field of the current node, located at free offset, and the key of the first child is copied to the key field of the node. After exiting the innermost loop, free offset is increased by one. To determine when to exit the innermost loop, the key field at the current offset is compared to the previous key field while taking into account only the parts of the keys that are relevant for the current level (relevant parts of keys decreases as the construction commences upwards in the breakdown) as well as the current, free, and next offset variables.

As for the comparison between keys with respect to depth a mask is used to omit parts of the key corresponding to levels already constructed in the comparison. That is, for the bottom level, the whole key is used. For the next level, a mask is used that zeros out the parts of the key that contains the last field of the breakdown and so on. Preferably, these masks can be prepared in advance and stored in an array where the depth is used directly to access the correct mask during comparison thus improving performance.

In FIG. 5 an example of a breakdown consisting of four levels is illustrated. To easily distinguish between the levels a darker shade of grey is used for the root node and then lighter shades of grey as we move down the tree towards the leaves. The references/pointers from parent nodes to the first children node of the respective parent is shown in 51 whereas the references/pointers from each node, except the root, to its parent node is shown in 52. In 53 we show the size of each node measured in number of children.

References/pointers can be stored in nodes as either memory addresses or integer offsets. Also note that this information is sufficient to determine for any given node whether it is a leaf or not and whether it is the root or not. Furthermore, if the node has siblings it is straight forward to determine if it is the first or last sibling and if not move to its previous or next sibling respectively. If the node has children, a children node can be directly accessed with a given index (assuming it is in range with respect to the node size). Finally, since the representation is implicit, or in-place, it is extremely conservative with respect to memory consumption and also supports fast traversal and processing.

Embodiments of the above scheme includes saving memory by not storing pointers to parents in children and instead recomputing the aggregates for the whole tree after updates as well as emulating slave keys by using a function to extract fields directly from records instead of using the pre-processed slave key for sorting.

### Update Management

The third main problem is to manage 609 update of records to minimize the impact on existing breakdowns as well as minimize the computations required to update reports to reflect the changes after an update.

Most updates does not affect class fields. Therefore the update management algorithm is optimized to handle updates (changing absolute value, decreasing, increasing) of value fields that does not affect class fields. If there are no active breakdowns, an update simply means to change the contents of a records and nothing else is affected by the update. However, if there are active breakdowns, changing value fields typically affects one or more aggregates further up in the tree if any of the altered value fields subject to aggregation.

One strategy to minimize the computational overhead resulting from updates is to delay re-computation of aggregates as much as possible to the point when there is a request for reading the current value of the aggregate and then re-compute the aggregates of the nodes that are absolutely necessary. An advantage of this strategy is that the maintenance work resulting from a single update is minimized and independent of the number of breakdowns/aggregates affected by the update. However, the disadvantage is that whenever an aggregate is re-computed, all records involved needs to be accessed resulting in essentially the same amount of work as reconstruction of the aggregates from scratch.

Another extreme strategy is to update all aggregates affected by an update immediately after the update. This approach is very good if the frequency of reporting (reading aggregates) is extremely high compared to the frequency of updates. However, it requires that the path from handle to leaf and then all the way to the root node is updates for all affected aggregates, causing a very high computational overhead on each update.

To avoid the drawbacks of these two extremes, a strategy is proposed where the each update also updates the parent of the handle, i.e. the leaf of the implicit tree structure for each affected breakdown/aggregate. For each field, it is therefore necessary to keep track of the breakdowns affected by changing the field and it is also necessary to maintain a mapping from record and breakdown to the handle of the breakdown associated with the record. Otherwise, the leaf node to be updated, when updating the record, can not be located. The leaf node is then inserted into a task queue data structure associated with the aggregate if it is not already present in the task queue.

When issuing a report which requires re-computation, nodes from the task queue are dequeued and their parent nodes are updated and inserted (if not already present) in the same task queue. The re-computation of the aggregate is concluded when the root node is extracted from the task queue.

In the rare cases when an update affects one or more breakdowns, all affected breakdowns are marked invalid and re-constructed from scratch the next time a report is requested which is associated with an invalid breakdown.

As realized by the person skilled in the art, the method of the present invention according to the various embodiments and examples described in this context, are suitable to realize as a computer program or a computer readable program.

These and other advantages with, and aspects of, the present invention will become apparent from this disclosure and the accompanying drawings.

Although specific embodiments have been illustrated and described herein for purposes of illustration and exemplification, it is understood by those of ordinary skill in the art that the specific embodiments illustrated and described may be substituted for a wide variety of implementations without departing from the scope of the present invention. Those of ordinary skill in the art will readily appreciate that the present invention could be implemented in a wide variety of embodiments, including hardware and software implementations, or combinations thereof. This disclosure is intended to cover any embodiment defined by the wording of the appended claims.

1. A method for data mining of collected data records, where each data record has a number of fields including at least one class field and one or more non-class fields, the method comprising:
using a computing device including a processor and one or more computer memories having memory locations, for providing and handling a layered tree structure of the data records, where each layer corresponds to a class field;
storing the non-class fields in a packet array in groups of non-class fields that occupies consecutive memory locations starting with the group of fields that requires the largest representation;
recording for each non-class field, which group it belongs to and also an index of the field within its group;
recording the number of fields in each group for computing a location of an individual field of a data record as an offset from the start of the array containing the fields that requires the largest representation and providing a mapping scheme;
for class fields, performing an analysis for each individual class field to find a minimum number of bits required to represent the field and storing a master key;
constructing a breakdown by providing handles, wherein there is a handle for each data record and the handle contains a reference to the record it is associated with, wherein the handle contains a slave key which is a subset of the master key containing only the class fields included in the breakdown;
mapping the fields included in the breakdown such that the last field occupies the least significant bits of the slave key, the next last field occupies the next unused least significant bits and so on;
sorting the handles in increasing order with respect to the slave keys and
building the rest of the breakdown in the same array as the handles after the handles; and;
handling updates to optimize update of value fields that does not affect class fields.

2. The method according to claim 1, wherein handling updates includes delaying recomputation of aggregates.

3. The method according to claim 1, wherein handling updates includes updating all aggregates affected by an update immediately after the update.

4. The method according to claim 1, wherein handling updates includes updating a parent of the handle.

5. The method according to claim 1, wherein replications for property or identifier text fields are stored in a dictionary and represented by an integer in the data records.

6. The method according to claim 1, wherein the text fields are compressed further.

7. The method according to claim 1, wherein the class field values of each data record are stored tightly packed in the memory and provide a master key for the data record.

8. The method according to claim 1, wherein if it is necessary to preserve the order between handles with identical slave keys, a sorting algorithm is chosen accordingly.

9. The method according to claim 1, comprising the step of:
storing pointers to parents in children and recomputing the aggregates for the whole tree after updates and emulating slave keys by using a function to extract fields directly from data records.

10. An apparatus for data mining of collected data records, where each data record has a number of fields including at least one class field and one or more non-class field, the apparatus comprising:
a computing device including a processor and one or more computer memories having memory locations, for providing and handling a layered tree structure of the data records, where each layer corresponds to a class field, the computing device being configured to perform the steps according to claim 1.

11. A computer program product for data mining of collected data records, where each data record has a number of fields including at least one class field and one or more non-class field, for providing and handling a layered tree structure of the data records, where each layer corresponds to a class field, the computer program product comprising computer readable program code, when stored in a computer readable storage medium having memory locations and run on a processor being configured to perform the method according to claim 1.
